(19) United States
(12) Patent Application Publication
(10) Pub. No.: US 2024/0266519 A1
(43) Pub. Date: Aug. 8, 2024

(54) CATHODE ACTIVE MATERIAL FOR SECONDARY BATTERY

(71) Applicant: L&F CO., LTD., Daegu (KR)

(72) Inventors: Kyung Min KIM, Daegu (KR); Su Youn KWON, Daegu (KR); Jin Hyeon LIM, Daegu (KR); Sung Kyun CHANG, Daegu (KR); Doe Hyoung KIM, Daegu (KR)

(21) Appl. No.: 18/693,601

(22) PCT Filed: Nov. 5, 2021
(86) PCT No.: PCT/KR2021/016026

§ 371 Date: Apr. 15, 2024

(51) Int. Cl. H01M 4/36; H01M 4/02; H01M 4/525

(52) U.S. Cl. CPC H01M 4/366; H01M 4/525; H01M 2004/021; H01M 2004/028

(57) ABSTRACT

Disclosed is a cathode active material including a particle core, a surface bulk portion formed in an outer direction of the particle core, and a surface portion formed in an outer direction of the surface bulk portion to constitute an outermost layer of the active material, wherein the surface portion contains a resistance-reducing element capable of reducing a resistance increase rate of the active material, and the surface bulk portion contains a structure-stabilizing element capable of improving the structural stability of the active material, and the structure-stabilizing element has higher diffusion power than that of the resistance-reducing element under calcination conditions for producing an active material.

### TECHNICAL FIELD

The present invention relates to a cathode active material for secondary battery, and more specifically, to a cathode active material that mainly contains a resistance-reducing element in a surface portion and a structure-stabilizing element in a surface bulk portion, and thus has excellent properties.

### BACKGROUND ART

As portable devices have developed rapidly over the past few decades, secondary batteries have also developed rapidly and the application areas of secondary batteries have recently expanded to electric vehicles, power tools, bicycles, ESSs, or the like. Therefore, high-capacity secondary batteries are required.

Research is being actively conducted on high-Ni cathode active materials with a high Ni content to implement high-capacity secondary batteries, but it is very difficult to solve the problem of worsening structural instability, such as cation mixing, as Ni content increases.

In addition, as the Ni content increases, the residual lithium on the surface of the particle also increases and cleaning is required to remove the residual lithium. After the cleaning process, Ni²⁺ increases, converting a part of the surface of the active material to NiO, i.e. rock salt, thus negatively affecting the properties. A representative example is the problem of property deterioration due to increased resistance on the surface area and inside of the active material.

As a result, high-Ni cathode active materials have increased capacity as the Ni content increases, but have the problems of reduced lifespan and deteriorated resistance characteristics due to structural instability.

When an excess of doping material is added to reduce these problems, it is impossible to obtain relatively high capacity characteristics and it is very difficult to improve both lifespan and resistance characteristics. For these reasons, high Ni-content cathode active materials are not applied to actual products.

Therefore, there is increasing need for novel methods for solving these problems.

### DISCLOSURE

### Technical Problem

Therefore, the present invention has been made to solve the above and other technical problems that have yet to be solved.

Therefore, as a result of extensive research and various experimentation, the present inventors developed a new type of cathode active material including elements with specific characteristics at determined regions of the active material particle, and found that the cathode active material can suppress the increase in resistance during cleaning in the production process even if the Ni content is increased, improve structural stability to increase the lifespan, and secure high capacity characteristics. Based on this finding, the present invention was completed.

### Technical Solution

In accordance with an aspect of the present invention, provided is a cathode active material including a particle core, a surface bulk portion formed in an outer direction of the particle core, and a surface portion formed in an outer direction of the surface bulk portion to constitute an outermost layer of the active material,
wherein the surface portion contains a resistance-reducing element capable of reducing a resistance increase rate of the active material, and the surface bulk portion contains a structure-stabilizing element capable of improving the structural stability of the active material, and
the structure-stabilizing element has higher diffusion power than that of the resistance-reducing element under calcination conditions for producing the active material.

The present inventors identified that the increase in resistance due to cleaning in the production process of the active material mainly occurs on the surface of the active material, and that structural instability mainly occurs in the particle core as the inner part of the active material, and the surface bulk portion. Accordingly, the resistance-reducing element that can reduce the resistance increase rate is mainly located on the surface of the cathode active material to reduce the resistance increase rate even after cleaning, and the structure-stabilizing element that can improve structural stability is mainly located on the surface bulk portion, thereby improving the characteristics related to capacity/lifespan/resistance increase rate to desired levels.

In particular, the cathode active material of the present invention is applicable to a cathode active material with a high Ni content, which has the problem of structural instability resulting from severe cation mixing due to the high Ni content, for example, a cathode active material with a Ni content of 60 mol % or more, 70 mol % or more, more preferably 80 mol % or more, and particularly preferably 90 mol % or more, based on the total content of the transition metal.

The cathode active material of the present invention includes a particle core, a surface-bulk portion, and a surface portion formed sequentially from the center of the particle outward on the vertical cross-section of the particle, and these portions may be divided by the presence or absence of the resistance-reducing element and the structure-stabilizing element, and/or the difference in concentration therebetween.

The resistance-reducing element is primarily contained in the surface portion, but may also be present in the surface bulk portion. Likewise, the structure-stabilizing element is primarily contained in the surface bulk portion, but may also be present in the surface portion.

Therefore, the resistance-reducing element and the structure-stabilizing element may be contained in both the surface bulk portion and the surface portion. However, in this case, there may be present a concentration difference between the elements, where the concentration of the structure-stabilizing element is relatively high in the surface bulk portion and the concentration of the resistance-reducing element is relatively high in the surface portion.

In some cases, the resistance-reducing element and the structure-stabilizing element may be contained in the particle core as well. In this case, the concentration of the structure-stabilizing element in the particle core may be relatively high.

In one specific example, a ratio of the concentration per unit volume of the resistance-reducing element (C_{M1}) to the concentration per unit volume of the structure-stabilizing element (C_{M2}) may be set to satisfy the following conditions for each portion.

$$[ Core portion ] 0.1 < {C}_{M 1} / {C}_{M 2} < 0.5$$

$$[ Surface bulk portion ] 0.5 \leq {C}_{M 1} / {C}_{M 2} < 1$$

$$[ Surface portion ] 1 < {C}_{M 1} / {C}_{M 2} < 10$$

Designing the structure-stabilizing element and the resistance-reducing element so as to be selectively and/or mainly distributed in specific regions of the cathode active material, i.e., the particle core, the surface bulk portion, and the surface portion may be controlled by the difference in diffusion power under calcination conditions for the production of the active material. The diffusion power of elements under calcination conditions may be expressed as the diffusion rate and diffusivity of the elements during calcination, and the difference in diffusion power causes the structure-stabilizing element and the resistance-reducing element to be optionally and/or dominantly distributed in the particle core, the surface bulk portion, and the surface portion.

Therefore, as previously defined, since the diffusion power of the structure-stabilizing element is higher than the diffusion power of the resistance-reducing element, during calcination, the structure-stabilizing element has a higher probability of diffusing toward the particle core, and the resistance-reducing element has a higher probability of being present on the surface portion. As a result, the structure-stabilizing element and the resistance-reducing element diffuse into the surface and interior of the active material and are incorporated into the crystal lattice when calcined, and are bonded to Li-(transition metal)-O₂ to form the particle core-surface bulk portion-surface portion.

When the cathode active material of the present invention is in the form of secondary particles in which primary particles are aggregated, the concentration of the resistance-reducing element and the structure-stabilizing element in the grain boundaries formed between primary particles and inside the primary particles may be changed depending on the calcination conditions. For example, in the surface bulk portion, the structure-stabilizing element diffuses along the grain boundary, so the concentration of the structure-stabilizing element may be higher on the surface of the primary particle, that is, at the grain boundary, whereas, in the surface portion, the resistance-reducing element diffuses along the grain boundaries, so the concentration of the resistance-reducing element may be higher at the grain boundary than inside the primary particle.

In one specific example, the size of the surface bulk portion may range from 5% to 30% based on the radius of the active material particle on a vertical cross section, and the size of the surface portion may range from 1% to 20% based on the radius of the active material particle on a vertical cross section.

The resistance-reducing element, for example, includes one or more selected from the group consisting of Zr, W, Nb, Mo, Ta and Y, and the structure-stabilizing element, for example, includes one or more selected from the group consisting of Ti, Al, B, K, V, Mg, Fe, Nb, Mo, Ta, and Y. At this time, the resistance-reducing element and the structure-stabilizing element are designed to be contained as different element combinations in the cathode active material due to the difference in diffusion power even though identical examples of some elements are provided as the resistance-reducing element and the structure-stabilizing element.

In one specific example, the cathode active material of the present invention may have the composition of Formula 1 below:

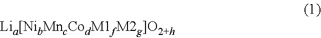

wherein M1 includes at least one selected from the group consisting of Zr, W, Nb, Mo, Ta and Y;
M2 includes at least one selected from the group consisting of Ti, Al, B, K, V, Mg, Fe, Nb, Mo, Ta and Y and is different from M1; and a, b, c, d, e, f, g, and h satisfy 0.9≤a≤1.5, 0.9<b+c+d+e+f+g<1.5, and −0.5≤h≤1.5.

When the cathode active material has the composition, the element contents of the particle core, the surface bulk portion, and the surface portion may satisfy the conditions for each portion below:

$$< Content conditions for each portion >$$

$$[ Core portion ] 0.5 \leq b < 1 , 0 \leq c < 1 ,$$

$$0 \leq d < 1 , 0 \leq f < 0.02 , 0 < g < 0.05 , g > f$$

$$[ Surface bulk portion ] 0 \leq b < 1 , 0 \leq c < 1 ,$$

$$0 \leq d < 1 , 0 \leq f < 0.02 , 0 < g < 0.05 , g > f$$

$$[ Surface portion ] 0 \leq b < 1 , 0 \leq c < 1 ,$$

$$0 \leq d < 1 , 0 < f < 0.02 , 0 \leq g < 0.05 , f > g$$

The concentration of the resistance-reducing element may range, for example, from 500 to 3,500 ppm or 0.0005 to 0.0035 mol, and the concentration of the structure-stabilizing element may range, for example, from 1,500 to 7,000 ppm, or 0.003 to 0.014 mol.

The present invention also provides a secondary battery, particularly, a lithium secondary battery, containing the cathode active material. General configuration of secondary batteries and methods of manufacturing the same are well known in the art and thus detailed descriptions thereof are omitted herein.

### Effects of the Invention

As described above, the cathode active material according to the present invention mainly contains resistance-reducing elements in the surface portion to reduce resistance increase rate even after cleaning, and mainly contains the structure-stabilizing element in the surface bulk portion to improve lifespan characteristics, thereby improving the characteristics related to capacity/lifespan/resistance increase rate to the desired levels.

### DESCRIPTION OF THE DRAWINGS

FIG. 1 is a graph showing nano-SIMS data associated with particle distribution from the surface to the center of the particles in the cathode active material of Example 1.

### BEST MODE

Now, the present invention will be described in more detail with reference to the following examples. These examples should not be construed as limiting the scope of the present invention.

### Comparative Example 1

An aqueous metal salt solution with a Ni:Co:Mn ratio of 90:6:4 was continuously supplied along with an aqueous solution of ammonia and caustic soda to a 500 L cylindrical reactor. The pH of the resulting mixture in the reactor was adjusted to 11.0 to 12.0, the ammonia concentration in the reactor was adjusted to a concentration to 4,000 to 5,000 ppm, and synthesis was performed by coprecipitation at a stirring speed of 380 rpm and at 60° C. for 30 hours. The synthesized result was washed, filtered and dried at 120° C. for 24 hours. As a result, a composite transition metal hydroxide powder with a D50 of 10 μm was prepared. The prepared coprecipitation compound was filtered, washed with water, and dried in a warm air dryer at 110° C. for 15 hours to obtain an active material precursor (“first precursor”).

The prepared first precursor and LiOH at a ratio of Li/Metal=1.02 were mixed under the setting conditions of 100 rpm/1 min→400 rpm/5 min→500 rpm/15 min in a 300 L mixer (Nippon Coke & Engineering), and calcined at 730° C. for 30 hours to prepare a cathode active material.

### Comparative Example 2

A cathode active material was prepared under the same conditions of the ratio of the first precursor to LiOH, mixing, and calcination as in Comparative Example 1, except that a TiO₂ additive was mixed at 1,500 ppm during mixing of the precursor with LiOH.

### Comparative Example 3

A cathode active material was prepared under the same conditions of the ratio of the first precursor to LiOH, mixing, and calcination as in Comparative Example 1, except that a ZrO₂ additive was mixed at 1,500 ppm during mixing of the precursor with LiOH.

### Comparative Example 4

A cathode active material was prepared under the same conditions of the ratio of the first precursor to LiOH, mixing, and calcination as in Comparative Example 1, except that TiO₂ and ZrO₂ additives were mixed at 1,500 ppm, respectively, during mixing of the precursor with LiOH.

### Comparative Example 5

A cathode active material was prepared under the same conditions of the ratio of the first precursor to LiOH, mixing, and calcination as in Comparative Example 1, except that a TiO₂ additive was mixed at 3,500 ppm during mixing of the precursor with LiOH.

### Example 1

A cathode active material was prepared under the same conditions of the ratio of the first precursor to LiOH, mixing, and calcination as in Comparative Example 1, except that TiO₂ and ZrO₂ additives were mixed at 3,500 ppm and at 1,500 ppm, respectively, during mixing of the precursor with LiOH.

### Example 2

A cathode active material was prepared under the same conditions of the ratio of the first precursor to LiOH, mixing, and calcination as in Comparative Example 1, except that TiO₂ and ZrO₂ additives were mixed at 4,500 ppm and at 1,500 ppm, respectively, during mixing of the precursor with LiOH.

### Example 3

A cathode active material was prepared under the same conditions of the ratio of the first precursor to LiOH, mixing, and calcination as in Comparative Example 1, except that TiO₂ and ZrO₂ additives were mixed at 3,500 ppm and at 500 ppm, respectively, during mixing of the precursor with LiOH.

### Example 4

A cathode active material was prepared under the same conditions of the ratio of the first precursor to LiOH, mixing, and calcination as in Comparative Example 1, except that TiO₂ and ZrO₂ additives were mixed at 3,500 ppm and at 1,000 ppm, respectively, during mixing of the precursor with LiOH.

### Example 5

A cathode active material was prepared under the same conditions of the ratio of the first precursor to LiOH, mixing, and calcination as in Comparative Example 1, except that TiO₂ and ZrO₂ additives were mixed at 3,500 ppm and at 2,500 ppm, respectively, during mixing of the precursor with LiOH.

### Example 6

A cathode active material was prepared under the same conditions of the ratio of the first precursor to LiOH, mixing, and calcination as in Comparative Example 1, except that TiO₂ and ZrO₂ additives were mixed at 3,500 ppm and at 3,500 ppm, respectively, during mixing of the precursor with LiOH.

### Example 7

An active material precursor (“second precursor”) was prepared under the same conditions as in the first precursor in Comparative Example 1, except that the NCM ratio was changed to 82:11:07.

The prepared second precursor and LiOH were mixed at a ratio of Li/Metal=1.02, and TiO₂ and ZrO₂ additives were each mixed at 1,500 ppm, respectively, during mixing of the precursor with LiOH to prepare a cathode active material.

### Example 8

An active material precursor (“third precursor”) was prepared under the same conditions as in the first precursor in Comparative Example 1, except that the NCM ratio was changed to 92:04:04.

The prepared third precursor and LiOH were mixed at a ratio of Li/Metal=1.02, and TiO₂ and ZrO₂ additives were each mixed at 1,500 ppm, respectively, during mixing of the precursor with LiOH to prepare a cathode active material.

### Example 9

An active material precursor (“fourth precursor”) was prepared under the same conditions as in the first precursor in Comparative Example 1, except that the NCM ratio was changed to 94:03:03.

The prepared fourth precursor and LiOH were mixed at a ratio of Li/Metal=1.02, and TiO₂ and ZrO₂ additives were each mixed at 1,500 ppm, respectively, during mixing of the precursor with LiOH to prepare a cathode active material.

### Example 10

An active material precursor (“fifth precursor”) was prepared under the same conditions as in the first precursor in Comparative Example 1, except that the NCM ratio was changed to 96:02:02.

The prepared fifth precursor and LiOH were mixed at a ratio of Li/Metal=1.02, and TiO₂ and ZrO₂ additives were each mixed at 1,500 ppm, respectively, during mixing the precursor with LiOH to prepare a cathode active material.

### Experimental Example 1

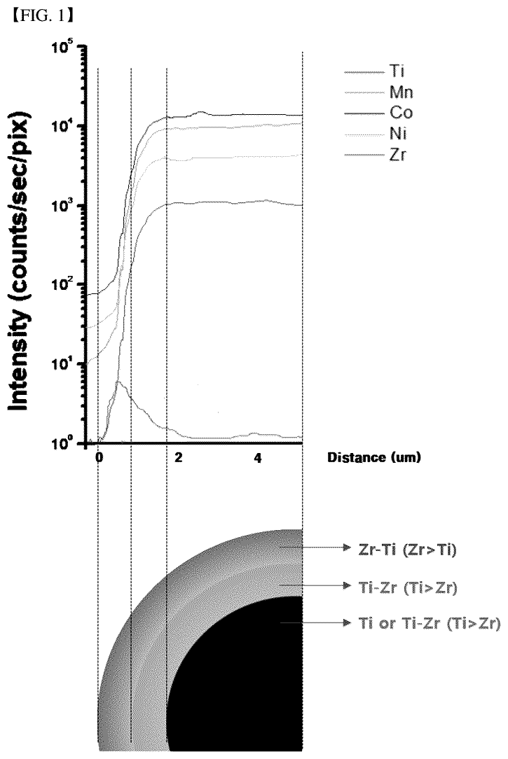

The cathode active material prepared in each of Comparative Examples 1 to 5 and Examples 1 to 10 was mixed with a conductive agent and a binder in a ratio of 96:2:2 (active material:conductive agent:binder), and the resulting mixture was applied to an aluminum current collector and then dried to produce a cathode. A secondary battery was manufactured by using lithium metal as an anode and adding an electrolyte EC/DMC/DEC=1/2/1 (vol %)+1 M LiPF₆+VC 2 wt % (E2DVC). Then, the electrochemical properties were measured and the results are shown in Table 1 below. In addition, the particles of the cathode active material prepared in Example 1 were analyzed using SIMS equipment to measure the concentration of elements in the direction from the particle surface to the center of gravity, and the results are shown in FIG. 1.

TABLE 1

| | | | | | Electrochemical properties | | |
|---|---|---|---|---|---|---|---|
| | Type | | | | | | Resistance |
| | of | Calcination | | | | Lifespan | increase |
| | active | temperature | Content of raw material (ppm) | | Capacity | (%,) | (%,) |
| Item | material | (° C.) | Zr | Ti | mAh/g | 30^{th}/1^{st} | 30^{th}/1^{st} |
| Comparative | Li[Ni_{0.90}Co_{0.06}Mn_{0.04}]O₂ | 730 | — | — | 220.0 | 90.1 | 100.0 |
| Example 1 | | | | | | | |
| Comparative | Li[Ni_{0.90}Co_{0.06}Mn_{0.04}]O₂ | | — | 1500 | 221.0 | 92.0 | 80.0 |
| Example 2 | | | | | | | |
| Comparative | Li[Ni_{0.90}Co_{0.06}Mn_{0.04}]O₂ | | 1500 | — | 220.7 | 91.8 | 90.0 |
| Example 3 | | | | | | | |
| Comparative | Li[Ni_{0.90}Co_{0.06}Mn_{0.04}]O₂ | | 1500 | 1500 | 219.0 | 92.3 | 80.0 |
| Example 4 | | | | | | | |
| Comparative | Li[Ni_{0.90}Co_{0.06}Mn_{0.04}]O₂ | | — | 3500 | 219.0 | 92.9 | 74.0 |
| Example 5 | | | | | | | |
| Example 1 | Li[Ni_{0.90}Co_{0.06}Mn_{0.04}]O₂ | 730 | 1500 | 3500 | 218.5 | 95.1 | 58.4 |
| Example 2 | Li[Ni_{0.90}Co_{0.06}Mn_{0.04}]O₂ | | 1500 | 4500 | 216.5 | 96.8 | 55.1 |
| Example 3 | Li[Ni_{0.90}Co_{0.06}Mn_{0.04}]O₂ | | 500 | 3500 | 218.0 | 94.3 | 72.8 |
| Example 4 | Li[Ni_{0.90}Co_{0.06}Mn_{0.04}]O₂ | | 1000 | 3500 | 218.0 | 94.7 | 60.0 |
| Example 5 | Li[Ni_{0.90}Co_{0.06}Mn_{0.04}]O₂ | | 2500 | 3500 | 218.0 | 95.0 | 58.0 |
| Example 6 | Li[Ni_{0.90}Co_{0.06}Mn_{0.04}]O₂ | | 3500 | 1500 | 216.3 | 92.1 | 68.4 |
| Example 7 | Li[Ni_{0.82}Co_{0.11}Mn_{0.07}]O₂ | 785 | 1500 | 1500 | 214.0 | 95.3 | 54.9 |
| Example 8 | Li[Ni_{0.92}Co_{0.04}Mn_{0.04}]O₂ | 730 | 1500 | 4500 | 221.0 | 95.1 | 61.7 |
| Example 9 | Li[Ni_{0.94}Co_{0.03}Mn_{0.03}]O₂ | 720 | 1500 | 5500 | 223.2 | 95.1 | 63.2 |
| Example 10 | Li[Ni_{0.96}Co_{0.02}Mn_{0.02}]O₂ | | 1500 | 6000 | 225.3 | 95.2 | 65.0 |

In the above examples, cathode active materials were manufactured using Zr as a resistance-reducing element and Ti as a structure-stabilizing element. Generally, when the Ni content was less than 80 mol %, calcination was performed at a high temperature of 800° C. or higher, and when the Ni content was 80 mol % or more, calcination was performed at a low temperature less than 800° C. Since the Ni content of all cathode active materials was 80 mol % or more, calcination was performed at a low temperature of less than 800° C.

Ti has a high diffusion power and thus diffuses to the particle core and the surface bulk portion even at low temperatures, whereas Zr has a low diffusion power and thus cannot diffuse to the inside and is more likely to exist on the surface so when the calcination temperature is low. In other words, since the diffusion power of Ti and Zr is affected by the calcination temperature and the calcination temperature is affected by the Ni content, these factors must be taken into consideration simultaneously to produce a cathode active material with the desired element distribution in the particle core, the surface bulk portion, and the surface portion.

As can be seen from Table 1, the characteristics of capacity/lifespan/resistance increase rate differ depending on the contents of Zr and Ti.

First of all, Zr does not significantly affect the capacity between 500 and 3,500 ppm and reduces the rate of resistance increase. However, when the Zr content exceeds 3,500 ppm, impurities such as LiₓZr_{y}O may be produced, which may affect the deterioration of capacity and lifespan characteristics.

As the Ti content increases, the capacity decreases, but the lifespan characteristics are improved. Therefore, Ti is preferably used in an appropriate content between 1,500 and 7,000 ppm.

In addition, as can be seen from FIG. 1, Zr has a high concentration in the surface portion and then decreases in concentration towards the surface bulk portion and particle core, whereas Ti has a very low concentration in the surface portion, but increases in concentration toward the surface bulk portion and the particle core along with a transition metal such as Ni, Mn, or Co.

That is, Zr and Ti are located in both the surface bulk portion and the surface portion, and the concentration of Ti is higher than the concentration of Zr in the surface bulk portion whereas the concentration of Zr is higher than the concentration of Ti in the surface portion. Zr and Ti may be distributed somewhat uniformly while satisfying the concentration conditions described above, or may be located in the form of a concentration gradient. The concentration gradient may continuously increase or decrease, for example, from the particle core to the surface portion.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A cathode active material comprising:
a particle core;
a surface bulk portion formed in an outer direction of the particle core; and
a surface portion formed in an outer direction of the surface bulk portion to constitute an outermost layer of the active material,
wherein the surface portion contains a resistance-reducing element capable of reducing a resistance increase rate of the active material, and the surface bulk portion contains a structure-stabilizing element capable of improving structural stability of the active material, and
the structure-stabilizing element has relatively higher diffusion power than that of the resistance-reducing element under calcination conditions for producing the active material.

2. The cathode active material according to claim 1, wherein the cathode active material is a cathode active material with a high Ni content of 60 mol % or more, based on a total content of the transition metal.

3. The cathode active material according to claim 1, wherein the resistance-reducing element and the structure-stabilizing element are contained in both the surface bulk portion and the surface portion, and
a concentration of the structure-stabilizing element is relatively high in the surface bulk portion and a concentration of the resistance-reducing element is relatively high in the surface portion.

4. The cathode active material according to claim 1, wherein the resistance-reducing element and the structure-stabilizing element are each contained in the particle core, and
the concentration of the structure-stabilizing element in the particle core is relatively high.

5. The cathode active material according to claim 1, wherein a ratio of a concentration per unit volume of the resistance-reducing element (C_{M1}) to a concentration per unit volume of the structure-stabilizing element (C_{M2}) satisfies the following conditions for each portion:
[Core portion] 0.1<C_{M1}/C_{M2}<0.5
[Surface bulk portion] 0.5≤ C_{M1}/C_{M2}<1
[Surface portion] 1<C_{M1}/C_{M2}<10

6. The cathode active material according to claim 1, wherein the diffusion power comprises at least one of a diffusion rate or diffusivity.

7. The cathode active material according to claim 1, wherein a size of the surface bulk portion ranges from 5% to 30% based on a radius of the active material particle on a vertical cross section, and a size of the surface portion ranges from 1% to 20% based on a radius of the active material particle on a vertical cross section.

8. The cathode active material according to claim 1, wherein the resistance-reducing element comprises one or more selected from the group consisting of Zr, W, Nb, Mo, Ta and Y,
the structure-stabilizing element comprises one or more selected from the group consisting of Ti, Al, B, K, V, Mg, Fe, Nb, Mo, Ta, and Y, and
the resistance-reducing element and the structure-stabilizing element are contained as different element combinations in the cathode active material.

9. The cathode active material according to claim 1, wherein the resistance-reducing element is Zr and the structure-stabilizing element is Ti.

10. The cathode active material according to claim 1, wherein the cathode active material has the following composition of Formula 1 and element contents of the particle core, surface bulk portion, and surface portion satisfy the following conditions for each portion:
Liₐ[Ni_{b}Mn_{c}Co_{d}M1_{f}M2_{g}]O₂₊ₕ (1)
wherein M1 comprises at least one selected from the group consisting of Zr, W, Nb, Mo, Ta and Y;
M2 comprises at least one selected from the group consisting of Ti, Al, B, K, V, Mg, Fe, Nb, Mo, Ta and Y and is different from M1; and
a, b, c, d, e, f, g, and h satisfy 0.9≤a≤1.5, 0.9<b+c+d+e+f+g<1.5, and −0.5≤h≤1.5.
<Content conditions for each portion>
[Core portion] 0.5≤b<1, 0≤c<1, 0≤d<1, 0≤f<0.02, 0<g<0.05, g>f [Surface bulk portion] 0≤b<1, 0≤c<1,0≤d<1, 0≤f<0.02, 0<g<0.05, g>f [Surface portion] 0≤b<1, 0≤c<1,0≤d<1, 0<f<0.02,0≤g<0.05, f>g

11. The cathode active material according to claim 1, wherein the concentration of the resistance-reducing element ranges from 500 to 3,500 ppm or from 0.0005 to 0.0035 mol, and the concentration of the structure-stabilizing element ranges from 1,500 to 7,000 ppm or from 0.003 to 0.014 mol.

12. A secondary battery comprising the cathode active material according to claim 1.
